(19) United States
(12) Patent Application Publication
(10) Pub. No.: US 2005/0202810 A1
(43) Pub. Date: Sep. 15, 2005

(54) Mobile and landline connection

(76) Inventor: George LaPallo, Howell, NJ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/798,756

(22) Filed: Mar. 11, 2004

(51) Int. Cl. H04Q 7/20

(52) U.S. Cl. 455/426.1

(57) ABSTRACT

Systems, methods, and device are provided for a mobile and landline connection device. One embodiment includes providing a mobile and landline connection device having a landline communication link, a radio communication link, a processor, and a memory connected to one another. The method includes switching a communication connection for a mobile handset between the landline communication link and the radio communication link and transmitting address and contact information from the mobile handset to a landline handset when the mobile communication device is connected to the device.

### INTRODUCTION

Mobile handheld multifunction devices capable of both voice and data functions have proliferated in recent years. Certain mobile devices are capable of different network type connections. Examples of these different network types include the public switched telephone network (PSTN), mobile or wireless voice networks, e.g., public local mobile networks (PLMNs), IP networks, and public wireless local area networks (PwLANs), etc. Wireless networks include global systems for mobile (GSM) networks, american national standards institute (ANSI) networks (including those using code division multiple access (CDMA) technology), 802.11 standard, e.g., wireless fidelity (Wi-Fi) networks, as well as Bluetooth networks, as the same will be known and understood by one of ordinary skill in the art.

Certain connection devices allow users to connect their cellular phones to their wired home or office systems. Such devices do not provide the home phone device with full access to address and contact information contained on the cell phone or multifunction handheld device. This leaves the user with multiple phone number lists to manage between their landline handsets and their mobile devices.

### BRIEF DESCRIPTION OF THE DRAWINGS

FIG. 1 illustrates an embodiment of a mobile and landline connection device.

FIG. 2 is a block diagram illustrating the interaction of various electronic components in an embodiment of a mobile and landline connection device.

FIG. 3 illustrates a mobile and landline connection device embodiment in communication with various networks.

FIG. 4 illustrates a method embodiment for a mobile and landline connection device.

FIG. 5 illustrates another method embodiment for a mobile and landline connection device.

### DETAILED DESCRIPTION

Embodiments of the present invention provide for a mobile and landline connection device. The device includes a processor, a memory, a landline link, and a mobile link connected with one another. As will be described more fully herein the landline link includes hardware and circuitry, including software and/or firmware executable thereon, to provide a connection to a landline communication medium as the same are known and understood by one of ordinary skill in the art, e.g., electrical signals across a physical connection via copper, coaxial cable, and/or fiber optics, or a combination thereof, to the PSTN. Likewise, the mobile link includes hardware and circuitry, including software and/or firmware executable thereon, to provide a connection to a wireless communication network, e.g. via radio frequency (RF) signals across an air interface to a GSM, CDMA, Wi-Fi, Bluetooth, etc., network.

Program embodiments (e.g., computer executable instructions) are provided to the memory and executable by the processor to control switching a communication connection for a mobile communication handset, e.g., cell phone, PDA, etc., between the landline link and the mobile link. Further, the program embodiments can execute instructions to transmit address and contact information from the mobile communication handset to a landline handset and the mobile and landline connection device when the mobile communication handset is connected to the device. Program embodiments can also execute instructions to transmit address and contact information from the device to the mobile communication handset. The mobile communication handset can include a multifunction device having a to-do list, a contact list, and an address book, etc. Together with the above functionality, program embodiments can execute instructions to transmit incoming mobile calls to the landline handset when the mobile communication handset is connected to the device and can execute instructions to transmit outgoing mobile calls via the landline link to a landline network. Likewise, program embodiments can execute instructions to transmit outgoing calls from the landline handset via the mobile link to a wireless network.

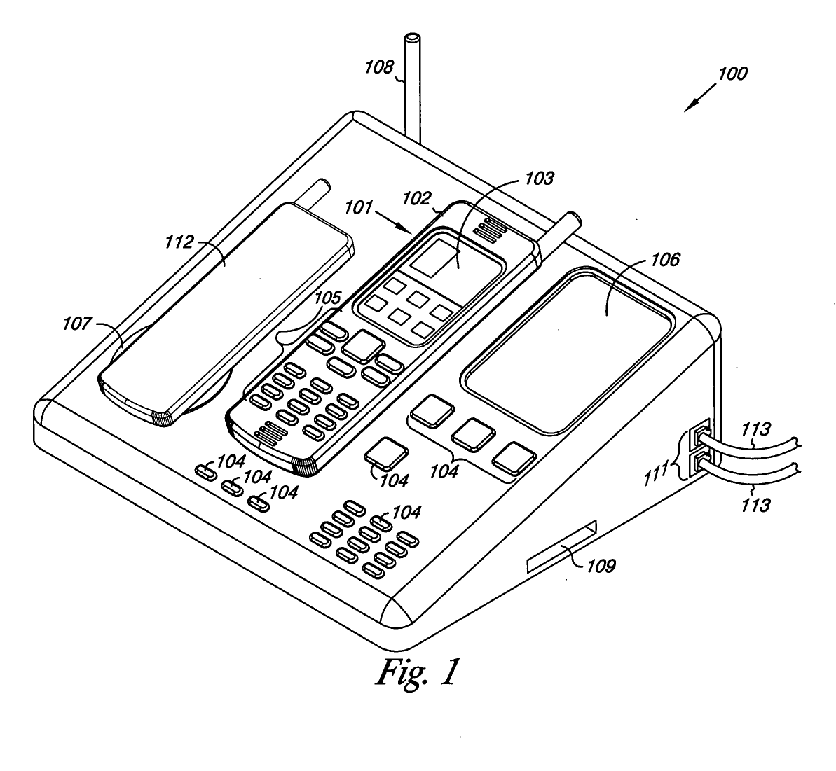

FIG. 1 illustrates an embodiment of a mobile and landline connection device 100. As shown in the embodiment of FIG. 1 the connection device 100 includes a cradle 101 to receive a mobile communication handset, e.g., a cell phone or other multifunction communication device, shown as 102. As shown in FIG. 1, a mobile communication handset includes a display 103 and one or more input keys and/or function keys, shown as 105. The connection device is also provided with one or more input keys and/or function keys 104. As shown in the embodiment of FIG. 1 the connection device includes a display 106. By way of example, and not by way of limitation, the display can include a liquid crystal display (LCD), touch panel display, thin film transistor display, or other suitable display technology provided either in color or black and white format.

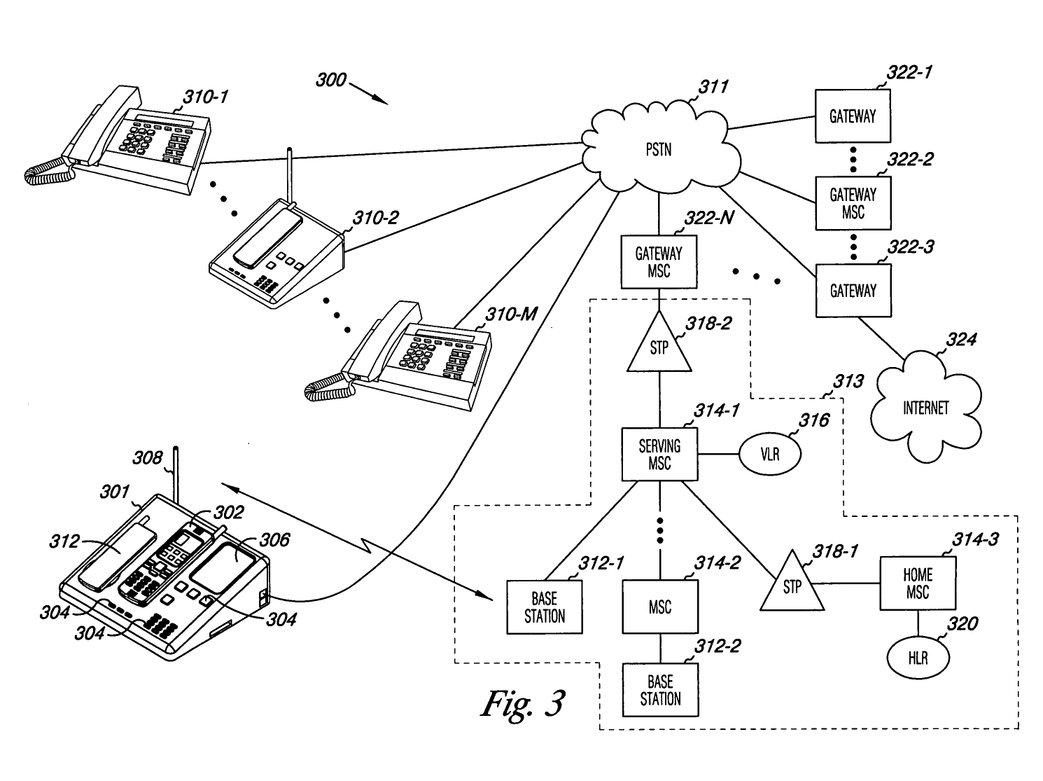

The embodiment of FIG. 1 further illustrates that the connection device 100 can include a speaker and/or microphone 107 as the same are known in the art. As shown in FIG. 1 the connection device 100 includes an external antenna 108 as the same are known in the art. As will be explained in more detail in connection with FIG. 3, the external antenna 108 is used to transmit and receive radio frequency (RF) signals (among a number of different radio frequencies), e.g., a radio communication or mobile link, in exchange with another RF device. It is noted that the external antenna can additionally serve in a dual role, switching between a landline link service transmitting and receiving RF frequencies suited to cordless telephone operation and a wireless link service transmitting and receiving RF frequencies suited to the standards of a mobile or wireless carrier network. This is discussed in more detail below in connection with FIG. 3. As one of ordinary skill in the art will appreciate, an external antenna 108 can boost reception via a radio communication link.

Further shown in the embodiment of FIG. 1, the connection device 100 can include a data port 109 as the same are known and understood by one of ordinary skill in the art. Also, as shown in FIG. 1, the connection device 100 can include one or more physical landline connections 111, e.g., a landline communication link, suited to transmit and receive electrical signal via a physical medium 113 such as copper, coaxial cable, and/or fiber optics. By way of example and not by way of limitation, the one or more physical landline connections can include an RJ-11 telephone jack as the same are known and understood in the art. As shown in the embodiment of FIG. 1, the mobile and landline device 100 includes a handset 112 as the same is known and understood by one of ordinary skill in the art.

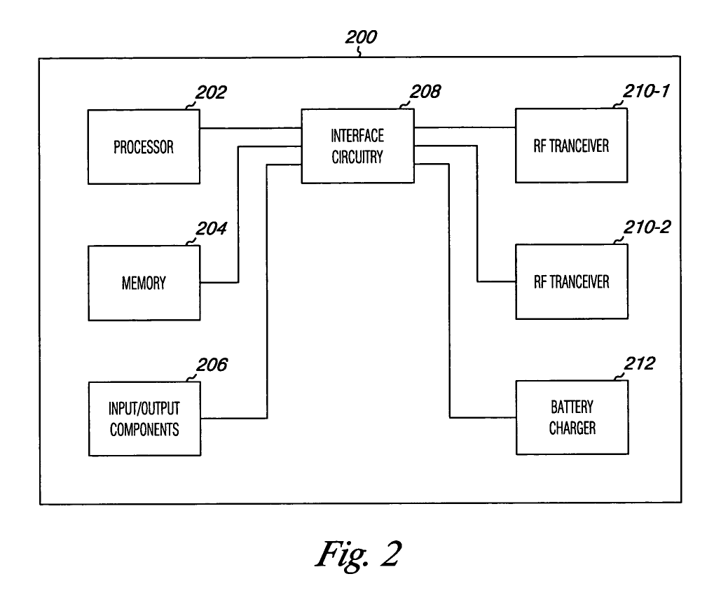

FIG. 2 is a block diagram illustrating the interaction of various electronic components in an embodiment of a mobile and landline connection device 200. The connection device 200 can serve as the connection device shown as 100 in FIG. 1. As shown in the embodiment of FIG. 2 the electronic components include a processor 202, a memory 204, and various input/output (I/O) components 206 connected via interface circuitry 208. One of ordinary skill in the art will appreciate upon reading this disclosure the various types of suitable interface circuitry 208 able to connect the processor 202 and memory 204, as well as suitable processor 202 and memory 204 resources sizeable according to various designs for implementation on the connection device 200. As one of ordinary skill in the art will appreciate upon reading this disclosure, in various embodiments the processor 202, memory 204, and interface circuitry 208 can be implemented as separate chipsets connected together and/or as combined components on one integrated circuit. Embodiments of the invention are not so limited.

As one of ordinary skill in the art will appreciate upon reading this disclosure, the I/O components 206 can include user input keys, including function keys, e.g., shown as 104 in FIG. 1. The I/O components 206 can include a display, touch panel or otherwise, a data port, and a speaker and/or microphone, e.g., shown as 106, 109, and 107 respectively in FIG. 1. Likewise, the I/O components can include an antenna and one or more physical landline connections, e.g., shown as 108 and 111 respectively in FIG. 1. The electrical components can further include a battery charger to charge a battery on the mobile communication handset 102 as the same will be known and understood by one of ordinary skill in the art.

As shown in the in the embodiment of FIG. 2, the I/O components can include a number of RF transceivers, separately enumerated as 210-1 and 210-2. As will be explained in more detail below one of the RF transceivers, e.g., 210-1, may be implemented to transmit and receive RF frequencies suited to cordless telephone operation, e.g., in the 900 MHz range, and another of the RF transceivers may be implemented to transmit and receive RF frequencies suited to the standards of a mobile or wireless carrier network, e.g., in the 824-849 MHz and 869-894 MHz range.

As will be described in more detail below, the various components shown in FIG. 2 can be controlled by instructions, e.g., software and/or firmware, executed by the processor 202. Such instructions can be stored in memory 204 or received from sources external to the connection device 200, e.g., via a data port or other I/O component. As will be understood by one of ordinary skill in the art upon reading this disclosure, the processor 202 can receive and act upon input instructions from the I/O components described above. Program embodiments, e.g., software and/or firmware, are also stored in memory 204 and executable by the processor 202 to transmit address and contact information from a mobile communication handset, e.g., 102 as shown in FIG. 1, to the device when the mobile communication handset is connected to the device. For example, a given mobile communication handset, e.g., 102 as shown in FIG. 1, can within an operating area use a technology such as Bluetooth and/or Wi-Fi (Wireless Fidelity) protocols, among others, to transmit address and contact information between handsets. To further explain, the 802.11 family of IEEE standards for wireless LANs (WLANs) can be used to transmit address and contact information between handsets. The IEEE 802.11 a standard, for example, transmits in the 5 GHz frequency range and provides from 6 to 54 Mbps. The IEEE 802.11b standard, generally referred to as Wi-Fi, transmits in the 2.4 GHz frequency range and provides from 1 to 11 Mbps. Each of these exemplary technologies provides a respective range or coverage area for access, as the same is known and understood by one of ordinary skill in the art. Additionally, the information can be transferred using infra-red transmission protocol as the same is known and understood by one of ordinary skill in the art. Embodiments, however, are not limited to these examples. More discussion is provided in connection with FIG. 3 as to example methods by which the mobile communication handset can connect, e.g., register, with the device.

Program embodiments can execute instructions to store the address and contact information, received from the mobile communication handset, on the device. One of ordinary skill in the art will appreciate the various manners in which program instructions executable on a processor can store data to memory.

Program embodiments can execute instructions to includes display the address and contact information on the device 200, e.g., via display 106 and/or using the display 103 of the mobile communication handset itself, based on user input to an I/O component. Program embodiments are stored in memory 204 and executable by the processor 202 to selectably choose, e.g., based on user input to a function key on the device, a touch panel display, or other I/O component such as shown in FIG. 1, the address and contact information as part of placing a call, storing and/or updating address and contact information on the device. For example, program embodiments can execute instructions to update selectably update, e.g., based on user input to a function key on the device, a touch panel display, or other I/O component such as shown in FIG. 1, address and contact information on the device 200.

As one of ordinary skill in the art will recognize, a mobile communication handset, such as a PDA/communication handset, can include a multifunction device having a to-do list, a contact list, and an address book, etc. Program embodiments can also execute instructions to transmit address and contact information, such as described above, from the device to the mobile communication handset when the mobile communication handset is connected to the device.

In various embodiments, as will be explained in more detail below, program instructions stored on memory 204 and executed by the processor 202 control switching a communication connection for a mobile communication handset between landline communication link and the radio communication link, e.g., 108 and/or 111 in connection with FIG. 1. Program embodiments further can execute instructions to automatically and/or selectably, e.g., based on user input to an I/O component, transmit incoming calls to the mobile communication handset to the landline handset when the mobile communication handset is connected to the device. The program embodiments can execute instructions to transmit incoming mobile calls to a number of landline handsets and the mobile communication handset when the mobile communication handset is connected to the device. For examples of how program embodiments can execute instructions to perform the above, reference is made to the following U.S. patents: U.S. Pat. No. 5,715,296, entitled “Concurrent Wireless/Landline Interface Apparatus”, issued Feb. 3d, 1998, and assigned to Telular Corp.; U.S. Pat. No. 6,405,042, entitled “Provision of Cellular/Wire-Line Service”, issued Jun. 11th, 2002, and assigned to Lucent Technologies, Inc.; U.S. Pat. No. 6,611,692, entitled “Cordless Cellular System”, issued Aug. 26, 2003, and assigned to AT&T Wireless Services, Inc.; U.S. Pat. No. 5,664,005, entitled “Personal Communications Service Using Wireline/Wireless Integration”, issued Sep. 2d, 1997, and assigned to Bell Atlantic Network Services, Inc.

Further, the various program embodiments can be stored on memory 204 and executed by the processor 202 to selectably, e.g., based on user input to an I/O component, transmit calls from the landline handset through the radio communication link, as described in connection with FIG. 1, when the mobile communication handset is connected to the device. For example, program instructions can execute to selectably forward calls placed to the landline handset through the landline communication link to the mobile communication handset when the mobile communication handset is not located in the cradle. The program embodiments can execute instructions to selectably, e.g., based on user input to an I/O component, transmit calls placed from the mobile communication handset through the landline communication link when the mobile communication handset is connected to the device. For examples of the manner in which the various program embodiments can execute to achieve the same, reference is directed to the above cited U.S. patents.

FIG. 3 illustrates a mobile and landline connection device in communication with various networks 300. For example, the embodiment of FIG. 3 illustrates a mobile and landline connection device 301, as described in connection with FIGS. 1 and 2, in communication with the PSTN 311, the internet 324, and a mobile network, or wireless telecommunications network 313. The mobile network 313 can include a mobile network operated by an industry wireless provider or operator, e.g., Cingular, Vodafone, Verizon, Nextel, Sprint, and T-Mobile are present wireless providers.

FIG. 3 illustrates a number of landline telecommunication devices, e.g., landline handsets 310-1, 310-2, . . . , 310-M, connected to the PSTN 311. The designator “M” is used to note that a number of landline telecommunication devices can be connected to the PSTN 311 from one or more physical locations as the same will be known and understood by one of ordinary skill in the art. The landline handsets can include cordless handsets, e.g., 310-2. One of ordinary skill in the art will appreciate the manner in which landline telecommunication devices in a home, office, or otherwise can be connected to the PSTN 311. Further description is not provided here so as not to obscure embodiments of the invention.

As shown in the embodiment of FIG. 3, a mobile and landline connection device 301, as described above in connection with FIGS. 1 and 2, is in communication with the various networks 300 described above. As described in connection with FIGS. 1 and 2 the mobile and landline connection device 301 can include one or more physical landline connections, e.g., a landline communication link shown as 111 in FIG. 1, suited to transmit and receive electrical signals via a physical medium such as copper, coaxial cable, and/or fiber optics. By way of example and not by way of limitation, the one or more physical landline connections can include an RJ-11 telephone jack as the same are known and understood in the art. As such, the mobile and landline connection device 301 is portable and can be disconnected and reconnected to an RJ-11 telephone jack in different locations.

Further, as described in connection with FIGS. 1 and 2, the mobile and landline connection device 301 includes an antenna, e.g., 308, among the other components discussed above. The antenna 308 is used to transmit and receive radio frequency (RF) signals (among a number of different radio frequencies), e.g., a radio communication or mobile link, in exchange with another RF device. In various embodiments the antenna 308 serves a dual role switching between a landline link service transmitting and receiving RF frequencies suited to cordless telephone operation, e.g., to communicate with cordless handset 312 connected to the PSTN 311, and a wireless link service transmitting and receiving RF frequencies suited to the standards of a mobile or wireless carrier network, e.g., to communicate with mobile communication handset 302 connected to a mobile network 313 via a base station 312-1. For example, as described above the I/O components of the mobile and landline connection device 301 can include a number of RF transceivers separately suited to transmit and receive RF frequencies for cordless telephone operation, e.g., in the 900 MHz range, and RF frequencies for a mobile or wireless carrier network, e.g., in the 824-849 MHz and 869-894 MHz range. One of ordinary skill in the art will understand upon reference to the above cited U.S. patents, e.g., U.S. Pat. No. 5,715,296, entitled “Concurrent Wireless/Landline Interface Apparatus”, issued Feb. 3d, 1998, and assigned to Telular Corp.; U.S. Pat. No. 6,405,042, entitled “Provision of Cellular/Wire-Line Service”, issued Jun. 11th, 2002, and assigned to Lucent Technologies, Inc.; U.S. Pat. No. 6,611,692, entitled “Cordless Cellular System”, issued Aug. 26, 2003, and assigned to AT&T Wireless Services, Inc.; U.S. Pat. No. 5,664,005, entitled “Personal Communications Service Using Wireline/Wireless Integration”, issued Sep. 2d, 1997, and assigned to Bell Atlantic Network Services, Inc., the various manners in which this may be performed.

Mobile networks 313, as shown in FIG. 3, may include ANSI/IS-41 and GSM MAP types of networks. American national standards institute (ANSI) networks using code division multiple access (CDMA), time division multiple access (TDMA) or technologies of the like, as well as global systems for mobile (GSM) type networks, are well known to those skilled in the art. Such a wireless networks can provide cellular/PCS (personal communication service) services like call origination and call delivery, streaming data, text messaging, etc., for an appropriately enabled roaming mobile device, e.g. a mobile communication handset 302. These wireless networks 313 include one or more mobile switching centers (MSCs) 314-1 and 314-2 which are connected to a plurality of base stations 312-1 and 312-2 that are dispersed throughout the geographic area serviced by the system. The geographic area serviced by a wireless telecommunications system is partitioned into a number of spatially distinct areas called “cells.” Each MSC 314-1 and 314-2 is responsible for, among other things, establishing and maintaining calls between mobile devices 302 and/or between a mobile device 302 and a wireline terminal which is connected to the wireless network from a local and/or long-distance networks, e.g., the regional Bells, Sprint, MCI, etc., in the PSTN 311.

An MSC 314-1 and 314-2 is a telephone switch specialized for wireless and mobility support. An MSC 314-1 and 314-2 performs various functions, including mobility management, call handoffs, call admission, call control, resource allocation, and so forth. A call and/or other data can be relayed from the MSC 314-1 and 314-2 to base stations 312-1 and 312-2 and via a wireless communication interface to the mobile device 302.

For example, whenever a mobile device 302 activates or roams into a new MSC coverage area, i.e., the “cell” for which a given MSC is responsible, the new MSC becomes the serving MSC, e.g., 314-1. A mobile device 302 can transmit its stored identity, e.g., its international mobile subscriber identity (IMSI), mobile subscriber integrated services digital network (MsISDN) number or the like, to the new serving MSC 314-1 via a base station 312-1. Subscriber identity information is transmitted over a radio channel in a format compliant with an air interface standard, e.g. ANSI/IS-41, GSM, etc., and detected by an antenna of the base station 312-1.

A base station, e.g., 312-1, transmits the subscriber identity information to the serving MSC 314-1 where it can be stored in a database associated with the MSC. In order to provide mobile service to the newly registered mobile device 302, the serving MSC 314-1 transmits a Mobile Application Part (MAP) based signal, such as a registration notification signal (IS-41 message) or location update signal (GSM message), to a home location register (HLR) 320 via a signaling link such as a signal transfer point (STP) 318-1. An HLR 320 is one such database in a cellular system that contains all the subscribers within the provider's home service area. A visiting location register (VLR), e.g., 316, is a similar type of database. For call delivery, a visited network uses the serving MSC 314-1 to track the location of a roaming user, e.g., mobile device 302, and a VLR 316 reports that location information via the mobile network to the HLR 320 of the home network. The VLR 316 can also request information from the HLR 320 in which case the data in the HLR 320 is transferred via SS7 to a VLR 316 in the new area. SS7 is the protocol used in the PSTN for setting up calls and providing services. The SS7 protocol sets up and tears down the call, handles all the routing decisions and supports all modern telephony services, such as 800 numbers, call forwarding, caller ID and local number portability (LNP), as the same are known and understood by one of ordinary skill in the art. An STP is a node in the signaling system 7 (SS7) telephone network that routes messages between exchanges and between exchanges and databases that hold subscriber and routing information. In voice networks, for example, voice switches known as service switching points (SSPs) query service control point (SCP) databases using packet switches known as signal transfer points (STPs).

As shown in the embodiment of FIG. 3, an STP, e.g., 318-2, can also route the MAP based signal to a gateway MSC, shown as 322-N. The designator “N” is used to note that a number of gateways can be included in connecting various communication networks as the same will be known and understood by one of ordinary skill in the art. As shown in the embodiment of FIG. 3, the gateway MSC 322-N can serve as a network switch, as the same are known and understood by one of ordinary skill in the art, for connecting to the public switched telephone network (PSTN) 311. As shown in FIG. 3, the PSTN 311 can be connected to a number of different gateways, e.g., 322-1, 322-2, . . . , 322-N, across multiple different network types. FIG. 3 illustrates the PSTN 311 connected to the Internet 324 via gateway 322-3. The Internet 324 can connect using TCP/IP to various other gateways (not shown) as the same is known and understood by one of ordinary skill in the art.

The MAP based signal, described above, can inform the HLR 320 of the network address associated with the MSC 314-1 currently serving the mobile device 302 and also request requisite subscriber information for providing mobile service to the roaming mobile device 302. The HLR 320 updates its database to store the network address representing the serving MSC 314-1 and also copies the requested subscriber information to the VLR 316 associated with the serving MSC 314-1. The network address representing the serving MSC 314-1 stored in the HLR 320 is later utilized by the mobile network to reroute any incoming call intended for the mobile device 302 to the serving MSC 314-1.

Program embodiments are stored on the memory, e.g., 204 in FIG. 2, and/or received from sources external to the connection device 301, e.g., via a data port or other I/O component. As will be understood by one of ordinary skill in the art upon reading this disclosure, a processor, e.g., 202 in FIG. 2, can execute instructions in the program embodiments to register and connect a mobile communication device, e.g., 302, to the mobile and landline connection device 301. For example, in much the same manner as the base station 312-1 and MSC 314-1 register when a roaming mobile device 302 has entered their respective “cell” the mobile and landline connection device 301 can register and connect to a given mobile device 302 when the mobile device 302 is within a particular distance of the connection device 301. Likewise, similar to a wireless access point in a local area network (LAN), as the same are known and understood by one of ordinary skill in the art, the connection device 301 can register when a given mobile device 302 is within its operating area using a technology such as Bluetooth and/or Wi-Fi (Wireless Fidelity) protocols, among others. For example, 802.11 is a family of IEEE standards for wireless LANs (WLANs). The IEEE 802.11 a standard, for example, transmits in the 5 GHz frequency range and provides from 6 to 54 Mbps. The IEEE 802.11b standard, generally referred to as Wi-Fi, transmits in the 2.4 GHz frequency range and provides from 1 to 11 Mbps. Each of these exemplary technologies provides a respective range or coverage area for access, as the same is known and understood by one of ordinary skill in the art. Therefore, when the mobile device 302 roams into the respective coverage area for access, be it in a residence or office environment, the mobile device 302 will attempt to authenticate and register with the connection device 301. Additionally, the program embodiments can execute to register the mobile device 302 when the mobile device is placed in a cradle, e.g., cradle 101 as shown in FIG. 1, as the same will be known and understood by one of ordinary skill in the art. Embodiments, however, are not limited to these examples.

Program embodiments, e.g., software and/or firmware, execute on the connection device 301 to transmit address and contact information from the mobile device 302 to the connection device 301 when the mobile device is connected, e.g., registered as described above, to the connection device 301. For example, the program embodiments, upon registering connection to the mobile device 302, can execute instructions to access a memory on the mobile device 302 and retrieve address and contact information therefrom. One of ordinary skill in the art will appreciate, upon reading this disclosure, the manner in which program instructions can be written to access a memory on the mobile device 302 and cause address and contact information to be transmitted and received by the connection device 301. For example, a given mobile device 302 can within an operating area use a technology such as Bluetooth and/or Wi-Fi (Wireless Fidelity) protocols, among others, to transmit address and contact information between the mobile device 302 and the connection device 301. To further explain, the 802.11 family of IEEE standards for wireless LANs (WLANs) can be used to transmit address and contact information between handsets. The IEEE 802.11 a standard, for example, transmits in the 5 GHz frequency range and provides from 6 to 54 Mbps. The IEEE 802.11b standard, generally referred to as Wi-Fi, transmits in the 2.4 GHz frequency range and provides from 1 to 11 Mbps. Each of these exemplary technologies provides a respective range or coverage area for access, as the same is known and understood by one of ordinary skill in the art. Additionally, the information can be transferred using infra-red transmission protocol as the same is known and understood by one of ordinary skill in the art. Program embodiments can further execute to store the address and contact information on a memory of the connection device 310.

Additionally, the program embodiments can execute to update, e.g., to modify, to add, and/or to delete, address and contact information on the connection device 301. That is, according to various embodiments the program instructions can execute to compare the address and contact information to address and contact information already stored on the connection device 301. If the program instructions execute to detect that new address and contact information is received, the program instructions can execute to add that information to memory on the connection device 310. Similarly, if the program instructions execute to detect that a particular set of address and contact information has changed from that previously stored in memory of the connection device 301, then the program instructions can execute to modify the address and contact information stored in the memory of the connection device 301 to reflect those changes. In the various embodiments, the program embodiments can execute instructions in a similar manner to transmit address and contact information from the connection device 301 to the mobile device 302. That is, the program embodiments can execute to update, e.g., to modify, to add, and/or to delete, address and contact information on the mobile device 302 and to store these updates on a memory of the mobile device 302. As one of ordinary skill in the art will appreciate upon reading this disclosure, the connection device 301 thus provides a device to collectively manage address and contact information between a landline handset connection, e.g., 310-1, 310-2, . . . , 310-M, and a mobile communication device 302.

As mentioned above, program embodiments are also executable on the mobile and landline connection device to control switching a communication connection for a mobile communication handset 302 between the landline communication link, e.g., 111 in FIG. 1, and the radio communication link, e.g., 108 in FIG. 1. As noted in connection with the Figures described herein, the radio communication link, e.g., 108, can provide an RF connection to both a landline connection, e.g., via frequencies suited to a cordless phone connection, and to a wireless connection, e.g., via frequencies suited to a wireless network connection, depending on a user selectable mode. For example, a user of the connection device 301 can provide input instructions, e.g., via I/O components described above, to select a mode of operation. The program embodiments execute instructions based on the received user input to switch the communication connection for a mobile handset between the landline communication link and the radio communication link. That is, the program embodiments can execute instructions to switch a communication connection for a mobile communication handset between a public switched telephone network (PSTN) and a mobile telecommunications network selected from the group of a CDMA based network and a GSM based network.

For example, the program embodiments can execute instructions to switch and enable a communication connection from the radio communication link, e.g., 108 in FIG. 1, to the landline communication link, e.g., 111 in FIG. 1. Similarly, the program embodiments can execute instructions to switch and enable a communication connection from the landline communication link, e.g., 111 in FIG. 1, to the radio communication link, e.g., 108 in FIG. 1. One of ordinary skill in the art will appreciate upon reading this disclosure the manner in which program instructions can be written to switch and enable a communication connection between the radio communication link and the landline communication link. Further, the program embodiments can execute instructions to switch and enable a communication connection from one RF transceiver type in the connection device 301, e.g., RF transceiver 210-1 in FIG. 2, to another RF transceiver type in the connection device 301, e.g., RF transceiver 210-2 in FIG. 2. Thus, by way of example and not by way of limitation, the program instructions can execute to employ the radio communication link, e.g., 108 in FIG. 1, to provide an RF connection to both a landline connection, e.g., via frequencies suited to a cordless phone connection, and to provide an RF connection a wireless connection, e.g., via frequencies suited to a wireless network connection, depending on a user selectable mode. One of ordinary skill in the art will appreciate upon reading this disclosure the manner in which program instructions can be written to switch and enable a communication connection from one RF transceiver type in the connection device 301, e.g., RF transceiver 210-1 in FIG. 2, to another RF transceiver type in the connection device 301, e.g., RF transceiver 210-2 in FIG. 2.

Thus, according to various embodiments, program instructions are provided which execute to transmit incoming mobile calls from a mobile network, e.g., 313 selected from the group of a CDMA based network and a GSM based network, to a landline handset, e.g., 310-1, 310-2, . . . , 310-M. Further, program instructions are provided which execute to transmit outgoing calls from the landline handset, e.g., 310-1, 310-2, . . . , 310-M, via the connection device 301, over a mobile network, e.g., 313 selected from the group of a CDMA based network and a GSM based network. Further, program instructions are provided which execute to transmit outgoing mobile calls from the mobile device 302 over a landline network, e.g., PSTN 311 when the mobile device is connected to the connection device 301 in one or more of the manners described above.

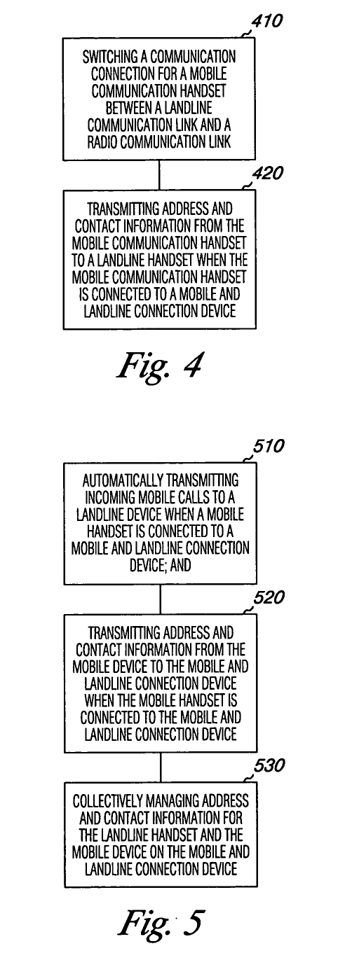

FIGS. 4-5 illustrate various method embodiments for connecting mobile and landline calls. As one of ordinary skill in the art will understand upon reading this disclosure, embodiments of the invention can be performed by software and/or firmware, application modules, e.g., computer executable instructions, operable on the systems and devices shown herein or otherwise. The invention, however, is not limited to any particular operating environment or to software and/or firmware written in a particular programming language.

Software, firmware, and application modules, suitable for carrying out embodiments of the present invention, can be resident in one or more devices or locations or in several locations in a distributed network.

One of ordinary skill in the art will appreciate that various components and/or devices described herein can include a computer readable medium, on which a set of computer executable instructions can reside. There are many forms of computer readable medium, including Flash memory, RAM, ROM, DDRAM, magnetic medium, optically read medium, and the like, which can be included in one and/or all of the various devices, components, and systems mentioned.

Unless explicitly stated, the method embodiments described herein are not constrained to a particular order or sequence. Additionally, some of the described method embodiments can occur or be performed at the same point in time.

FIG. 4 illustrates a method embodiment for a mobile and landline connection device. As shown in the embodiment of FIG. 4 the method includes switching a communication connection for a mobile communication handset between a landline communication link and a radio communication link in block 410. As described above, program embodiments execute instructions based on user input, e.g., via I/O components, and/or based on a mobile device entering an area and being registered with the mobile and landline connection device, to selectably switch a communication connection for a mobile device between the landline communication link and the radio communication link. For example, the program embodiments can execute to switch a communication connection for a mobile device between a public switched telephone network (PSTN) and a mobile telecommunications network. The mobile telecommunications network can include a network selected from the group of a CDMA based network and a GSM based network. As has been described above, a user can selectably execute program embodiments to switch and enable a communication connection from the radio communication link, e.g., 108 in FIG. 1, to the landline communication link, e.g., 111 in FIG. 1. Similarly, a user can selectably provide input instructions, e.g., via I/O components, to switch and enable a communication connection from the landline communication link to the radio communication link. One of ordinary skill in the art will appreciate upon reading this disclosure the manner in which program instructions can be written to switch and enable a communication connection between the radio communication link and the landline communication link.

Additionally, a user can selectably execute program embodiments, e.g., via I/O components, to switch and enable a communication connection from one RF transceiver type in the connection device, e.g., RF transceiver 210-1 in FIG. 2, to another RF transceiver type in the connection device, e.g., RF transceiver 210-2 in FIG. 2. In this manner, the program instructions can execute to employ the radio communication link, e.g., 108 in FIG. 1, to provide an RF connection to both a landline connection, e.g., via frequencies suited to a cordless phone connection, and to provide an RF connection a wireless connection, e.g., via frequencies suited to a wireless network connection. One of ordinary skill in the art will appreciate upon reading this disclosure the manner in which program instructions can be written to switch and enable a communication connection from one RF transceiver type in the connection device to another RF transceiver type in the connection device.

In block 420, the method further includes transmitting address and contact information from the mobile device to a landline handset when the mobile device is connected to a mobile and landline connection device. As described above, a user can selectably execute program instructions to connect the mobile device to the mobile and landline connection device when the mobile device is within a range of the mobile and landline connection device as described above and input instructions on the mobile and landline connection device, e.g., using the I/O components described in FIG. 1, and/or by entering input instructions to the mobile device, e.g., using the input keys 105 and/or touch panel display 103 on the mobile device as described in connection with FIG. 1. Additionally, the program instructions can execute to automatically connect the mobile device to the mobile and landline connection device whenever the mobile device is within a range of the mobile and landline connection.

To transmit address and contact information from the mobile device to a landline handset a user can similarly input instructions, e.g., via I/O components on the mobile device and/or on the connection device, to execute program embodiments, e.g., software and/or firmware stored on the connection device, to retrieve address and contact information from the mobile device. As noted above, one of ordinary skill in the art will appreciate, upon reading this disclosure, the manner in which program instructions can be written to access a memory on the mobile device and to cause address and contact information to be transmitted and received by the connection device. Program embodiments can further execute to store the address and contact information on a memory of the connection device. By way of example and not by way of limitation, upon registering a mobile device with the connection device, as the same has been described above, a user can selectably input instructions, e.g., via selecting a menu option on a touch panel display, 106 in FIG. 1, and/or via input keys, 104 in FIG. 1, to retrieve address and contact information from a memory of the mobile device and to store the address and contact information in a memory of the connection device. Additionally, a user can input instructions to selectably access address and contact information via a landline handset and display the address and contact information on a display of the connection device and/or the mobile device, e.g., 106 and 103 as shown in FIG. 1. Thus, the user can collectively access and manage address and contact information from the connection device and make the same available to a landline handset from a mobile device.

FIG. 5 illustrates another method embodiment for a mobile and landline connection device. As shown in the embodiment of FIG. 5, the method includes automatically transmitting incoming mobile calls to a landline handset when a mobile device is connected to a mobile and landline connection device in block 510. As described above, program embodiments execute to register a mobile device with the mobile and landline connection device. That is, a user can selectably execute program instructions to connect the mobile device to the mobile and landline connection device when the mobile device is within a transmitting and receiving range of the mobile and landline connection device as described above. A user can register and activate a connection with the mobile and landline connection device by inputting instructions on the mobile and landline connection device, e.g., using the I/O components described in FIG. 1, and/or by entering input instructions to the mobile device, e.g., using the input keys 105 and/or touch panel display 103 on the mobile device as described in connection with FIG. 1. Additionally, a user can selectively register and activate a connection with the mobile and landline connection device by inputting instructions on the mobile and landline connection device, e.g., using the I/O components described in FIG. 1, such that the program instructions execute to automatically connect the mobile device to the mobile and landline connection device whenever the mobile device is within a range of the mobile and landline connection.

Once connected a user can execute program instructions, e.g., based on user input instructions as described above, to switch a communication connection for a mobile device between a landline communication link and a radio communication link as described in connection with FIG. 4. Accordingly, a user can selectively execute program embodiments, based on user input, e.g., via I/O components, and/or automatically in a user selected mode based on a mobile device entering an area and being registered with the mobile and landline connection device, to selectably switch a communication connection for the mobile device such that incoming mobile calls are transmitted to a landline device, e.g., 310-1, 310-2, . . . , 310-M. Thus, the program embodiments can execute to switch a communication connection for a mobile device, via the mobile and landline connection device, from a mobile telecommunications network to one or more landline devices in one or more locations. One of ordinary skill in the art will appreciate upon reading this disclosure the manner in which program instructions can be written, stored on a memory of the connection device and executed by a processor thereon to transfer incoming mobile calls, received via the radio communication link, to the one or more landline handsets via the landline link of the connection device. Additionally, as described above, this can include a user can selectably execute program embodiments, e.g., via I/O components, to switch and enable a communication connection from one RF transceiver type in the connection device, e.g., RF transceiver 210-1 in FIG. 2, to another RF transceiver type in the connection device, e.g., RF transceiver 210-2 in FIG. 2. In this manner, the program instructions can execute to employ the radio communication link, e.g., 108 in FIG. 1, to provide an RF connection to both a landline connection, e.g., via frequencies suited to a cordless phone connection, and to provide an RF connection a wireless connection, e.g., via frequencies suited to a wireless network connection.

In block 520, the method further includes transmitting address and contact information from the mobile device to the mobile and landline connection device when the mobile device is connected to the mobile and landline connection device. Similar to the description provided in connection with FIG. 4, to transmit address and contact information from the mobile device to the mobile and landline connection device a user can input instructions, e.g., via I/O components on the mobile device and/or on the connection device, to execute program embodiments, e.g., software and/or firmware stored on the connection device, to retrieve address and contact information from the mobile device. As noted above, one of ordinary skill in the art will appreciate, upon reading this disclosure, the manner in which program instructions can be written to access a memory on the mobile device and to cause address and contact information to be transmitted and received by the connection device. As described in connection with FIG. 4, the program embodiments can execute to store the address and contact information on a memory of the connection device. By way of example and not by way of limitation, a user can selectably input instructions, e.g., via selecting a menu option on a touch panel display, 106 in FIG. 1, and/or via input keys, 104 in FIG. 1, to retrieve address and contact information from a memory of the mobile device and to store the address and contact information in a memory of the connection device. Additionally, a user can input instructions to selectably access address and contact information via a landline handset and display the address and contact information on a display of the connection device and/or the mobile device, e.g., 106 and 103 as shown in FIG. 1.

As shown in block 530, the method further includes collectively managing address and contact information for the landline handset and the mobile device on the mobile and landline connection device. To collectively access and manage address and contact information from the connection device program embodiments can execute instructions to update, e.g., to modify, to add, and/or to delete, address and contact information on the connection device. Thus in various embodiments as a user selectably executes the program instructions to transmit address and contact information from the mobile device to the connection device, the program instructions will execute to compare the address and contact information to address and contact information already stored on the connection device. If the program instructions execute to detect that new address and contact information is received, the program instructions can execute to add that information to memory on the connection device. Similarly, if the program instructions execute to detect that a particular set of address and contact information has changed from that previously stored in memory of the connection device, then the program instructions can execute to modify the address and contact information stored in the memory of the connection device to reflect those changes. In the various embodiments, the program embodiments can execute instructions in a similar manner to transmit address and contact information from the connection device to the mobile device. Likewise, the program instructions can execute to respond to user input instructions selecting a particular contact, e.g., phone number, on a touch panel display (106 in FIG. 1) of the connection device to place a call via the landline and/or radio communication link.

Thus, based on user input instructions the program embodiments execute to access and to update, e.g., to modify, to add, and/or to delete, address and contact information available to a landline handset, stored on the connection device, and/or on the mobile device. And, based on user input instructions, the program embodiments can execute to store these updates on a memory of the connection device and/or the mobile device.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A mobile and landline connection device, comprising:
a landline communication link;
a wireless communication link; and
wherein the connection device includes a processor, a memory, and program instructions provided to the memory and executable by the processor to:
control switching a communication connection for a mobile communication handset between the landline communication link and the wireless communication link; and
transmit address and contact information from the mobile communication handset to a landline handset when the mobile communication handset is connected to the device.

2. The device of claim 1, further including program instructions which execute to automatically transmit mobile calls to the landline handset when the mobile communication handset is connected to the device.

3. The device of claim 1, further including program instructions which execute to transmit address and contact information from the device to the mobile communication handset when the mobile communication handset is connected to the device.

4. The device of claim 1, wherein the device further includes:
a display;
a function key; and
a battery charger to charge a battery on the mobile communication handset.

5. The interface of claim 1, wherein the wireless communication link includes a connection to a mobile telecommunications network selected from the group of a CDMA based network and a GSM based network.

6. A mobile and landline connection device, comprising:
a landline communication link;
a radio communication link; and
wherein the device includes a processor, a memory coupled to the processor, and program instructions provided to the memory and executable by the processor to:
automatically transmit mobile calls received over the radio communication link to a landline handset when a mobile communication handset is connected to the device; and
transmit address and contact information from the mobile communication handset to the device when the mobile communication handset is connected to the device.

7. The device of claim 6, further including program instructions which execute to transmit address and contact information from the device to the mobile communication handset when the mobile communication handset is connected to the device.

8. The device of claim 6, wherein the device further includes:
a display;
a function key; and
a battery charger to charge a battery on the mobile communication handset.

9. The device of claim 6, wherein the radio communication link includes a connection to a mobile telecommunications network selected from the group of a CDMA based network and a GSM based network.

10. The device of claim 6, wherein the landline handset includes a cordless handset.

11. The device of claim 6, wherein the mobile communication handset includes a multifunction device having a to-do list, a contact list, and an address book.

12. The device of claim 6, further including program instructions which execute to selectably transmit calls from the landline handset through the radio communication link when the mobile communication handset is connected to the device.

13. The device of claim 6, wherein the device includes an external antenna to boost reception via the radio communication link when the mobile communication handset is connected to the device.

14. The device of claim 6, further including program instructions which execute to transmit mobile calls to a number of landline handsets and the mobile communication handset when the mobile communication handset is connected to the device.

15. The device of claim 6, wherein the device includes a cradle on which the mobile communication handset can seat.

16. The device of claim 15, further including program instructions which execute to selectably forward calls placed to the landline handset through the landline communication link to the mobile communication handset when the mobile communication handset is not located in the cradle.

17. A method for connecting mobile and landline calls, comprising:
providing a mobile and landline connection device having a landline communication link, a radio communication link, a processor, and a memory connected to one another;
switching a communication connection for a mobile handset between the landline communication link and the radio communication link; and
transmitting address and contact information from the mobile handset to a landline handset when the mobile handset is connected to the connection device.

18. The method of claim 17, wherein the method includes automatically transmitting mobile calls to the landline handset when the mobile communication handset is connected to the device.

19. The method of claim 17, wherein the method includes storing and updating address and contact information on the device.

20. The method of claim 19, wherein the method includes transmitting address and contact information from the device to the mobile communication handset when the mobile communication handset is connected to the device.

21. The method of claim 17, wherein the method includes displaying the address and contact information on the device and selectably choosing the address and contact information using a function key on the device.

22. The method of claim 17, wherein the method includes switching a communication connection for a mobile communication handset between a public switched telephone network (PSTN) and a mobile telecommunications network selected from the group of a CDMA based network and a GSM based network.

23. A method for connecting mobile and landline calls, comprising:
automatically transmitting incoming mobile calls to a landline handset when a mobile communication handset is connected to an access point device; and
transmitting address and contact information from the mobile communication handset to a landline handset when the mobile communication handset is connected to the access point device.

24. The method of claim 23, wherein the method includes transmitting and storing address and contact information to the access point device when the mobile communication handset is connected to the device.

25. The method of claim 23, wherein the method includes updating address and contact information on the access point device, the device having a processor, a memory, a display, and a function key coupled to one another.

26. The method of claim 23, wherein the method includes transmitting address and contact information from the access point device to the mobile communication handset when the mobile communication handset is connected to the device.

27. The method of claim 23, wherein the method includes displaying and selectably accessing address and contact information on the access point device.

28. The method of claim 23, wherein the method includes displaying and selectably accessing address and contact information from the access point device on a display of the mobile communication handset when the mobile communication handset is seated in a cradle of the device.

29. The method of claim 23, wherein the method includes transmitting incoming mobile calls from a mobile network selected from the group of a CDMA based network and a GSM based network to the landline handset.

30. The method of claim 23, wherein the method includes transmitting outgoing calls from the landline handset, via the access point device, over a mobile network selected from the group of a CDMA based network and a GSM based network.

31. The method of claim 23, wherein the method includes transmitting outgoing mobile calls from the mobile communication handset over a landline network when the mobile communication handset is connected to the access point device.

32. A computer readable medium having instructions for causing a device to perform a method, comprising:
switching a communication connection for a mobile communication handset between a landline communication link and a radio communication link on the device; and
transmitting address and contact information from the mobile communication handset to a landline handset when the mobile communication handset is connected to the device.

33. The medium of claim 32, wherein the method includes transmitting a to-do list, a contact list, and an address book from the mobile communication handset to the device.

34. The medium of claim 32, wherein the method includes transmitting a to-do list, a contact list, and an address book from the device to the mobile communication handset.

35. The medium of claim 32, wherein the method includes selectably transmitting calls from the landline handset through the radio communication link when the mobile communication handset is connected to the device.

36. The medium of claim 32, wherein the method includes selectably transmitting calls from the mobile communication handset through the landline communication link when the mobile communication handset is connected to the device.

37. The medium of claim 32, wherein the method includes transmitting incoming mobile calls to a number of landline handsets and the mobile communication handset when the mobile communication handset is connected to the device.

38. A mobile and landline connection device, comprising:
a processor, a memory, a landline link, and a mobile link connected with one another;
a seat for receiving a mobile communication device to connect with the processor, the memory, the landline link, and the mobile link; and
means for exchanging address and contact information between the mobile communication device and the connection device.

39. The device of claim 38, wherein the means for exchanging address and contact information includes a set of computer executable instructions.

40. The device of claim 38, further including program instructions stored on the memory and executable by the processor to switch a communication connection in association with the mobile communication device between the landline link and the mobile link.

41. The device of claim 40, wherein the device is a portable device, and wherein the device further includes program instructions to identify a particular landline to which the landline link connects.

42. The device of claim 41, further including program instructions stored on the memory and executable by the processor to transmit an identification number associated with the particular landline to a mobile switching center.

43. The device of claim 38, further including program instructions stored on the memory and executable by the processor to transmit address and contact information from the mobile communication device to a landline handset.

44. The device of claim 38, further including program instructions stored on the memory and executable by the processor to automatically transmit mobile calls to a landline handset connected to the device via the landline link.

45. The device of claim 38, further including program instructions stored on the memory and executable by the processor to store and update address and contact information on the device.

46. The device of claim 38, further including program instructions stored on the memory and executable by the processor to transmit address and contact information from the device to the mobile communication device.

47. The device of claim 38, further including program instructions stored on the memory and executable by the processor to display the address and contact information on the device and to selectably choose the address and contact information using a function key on the device.

48. The device of claim 38, wherein the device is connected to a communication network, the device further including program instructions stored on the memory and executable by the processor to:
switch a communication connection for the mobile communication device between a public switched telephone network (PSTN) and a mobile telecommunications network selected from the group of a CDMA based network and a GSM based network.
